(19) United States
(12) Patent Application Publication
(10) Pub. No.: US 2008/0056279 A1
(43) Pub. Date: Mar. 6, 2008

(54) Proactive Field Resource Planning Application

(76) Inventors: Yogesh Lund, Round Rock, TX (US); Robert Feiner, Austin, TX (US); Frank Shattuck, Austin, TX (US)

Correspondence Address: HAMILTON & TERRILE, LLP, P.O. BOX 203518, AUSTIN, TX, 78720, US

(21) Appl. No.: 11/468,337

(22) Filed: Aug. 30, 2006

(51) Int. Cl. H04L 12/56

(52) U.S. Cl. 370/400

(57) ABSTRACT

A comprehensive and flexible method for predicting field service head count requirements for optimized field delivery is disclosed. The headcount model predicts how many field service resources (be they internal resources or partner resources) are needed both for a particular timeframe and at a particular location. E.g., the resources can be predicted by quarter and as well as by geographic location (e.g., a city or region in the USA).

### BACKGROUND OF THE INVENTION

1. Field of the Invention

The present invention relates to the field of resource planning, and more particularly to proactive field resource planning applications.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One issue that affects information handling systems is servicing the information handling systems in the field. It can be challenging for information handling system suppliers, or other providers of field services to plan for the resources necessary to provide adequate service. In field services, demand is represented by the need for customers to have desired resources, at an appropriate time and location. Supply is represented by the availability and location of the resource. It can be challenging to proactively plan and adjust field service resource supply (resource availability, skill set and physical location) to meet resource demand. It is desirable to optimize cost and customer service levels for field service resources.

There are a number of challenging aspects to when proactively planning and adjusting field service resource supply. For example, there is often substantially constant change in both demand and supply parameters. The demand and supply parameters can include volume forecasts, which change due to market forces, a time required to perform a task on site changes with productivity improvements, attrition of employees at different locations throughout the year, and a sudden burst in volume for repair services due to failure of a product. The business data related to the demand and supply parameters are often not consolidated and in many cases information received is outdated.

Another challenging aspect related to planning and adjusting field service resource supply relates to the field service force. Often information handing service providers or other service suppliers, rely upon a number of different types of field service resources. For example, field service resources can include internal resources (i.e., employees) as well as dedicated partners and non-dedicated partners. Dedicated partners imply partner employees that are dedicated full time to working to particular projects. Non-dedicated implies partner resources that are contracted out for a specific project. In any case, it is desirable to effectively balance work load when working through partners to manage risk and cost associated with the partners.

### SUMMARY OF THE INVENTION

In accordance with the present invention, a comprehensive and flexible method for predicting field service head count requirements for optimized field delivery is set forth. The headcount model predicts how many field service resources (be they internal resources or partner resources) are needed both for a particular timeframe and at a particular location. E.g., the resources can be predicted by quarter and as well as by geographic location (e.g., a city or region in the USA).

The method includes a plurality of aspects. For example, the demand forecast method represents demand for a service as compared to conventional product based forecasts. Also, the demand forecast method takes into account several personnel related items such as attrition, ramp time and productivity improvements to predict headcount. Also, the demand forecast method provides headcount plans for both internal and partner resources. Also, the demand forecast method is flexible and can alter an internal to partner resource mix to incorporate changes in partner strategy. Also, the demand forecast method forecasts resources by location. In one embodiment, the demand forecast method includes a comprehensive model which maps mailing codes (such as zip codes) to a metropolitan area for which resources are provided.

In one embodiment, the invention relates to a computer implemented method for predicting field service resource needs. The method includes predicting a field service resource headcount, determining a field service resource load distribution, determining a field service resource location distribution, and generating a hiring plan for the field service resources based upon the headcount, field service resource load distribution and field service resource location distribution.

In another embodiment, the invention relates to a computer implemented apparatus for predicting field service resource needs. The apparatus includes means for predicting a field service resource headcount, means for determining a field service resource load distribution, means for determining a field service resource location distribution, and means for generating a hiring plan for the field service resources based upon the headcount, field service resource load distribution and field service resource location distribution.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a system block diagram of an information handling system.

FIG. 2 shows a flow chart of the operation of a demand forecast system.

FIG. 3 shows a flow chart of the operation of a headcount prediction module.

FIG. 4 shows a flow chart of the operation of a load distribution module.

FIG. 5 shows a flow chart of the operation of a resource location module.

FIG. 6 shows a flow chart of the operation of a hiring plan module.

FIG. 7 shows a series of sample screen presentations representing the operation of the demand forecast system.

FIG. 8 shows an example of a geographic distribution of a resource location module.

FIG. 9 shows sample screen presentations of the demand forecast system.

FIG. 10 shows a sample screen presentation of the demand forecast system.

### DETAILED DESCRIPTION

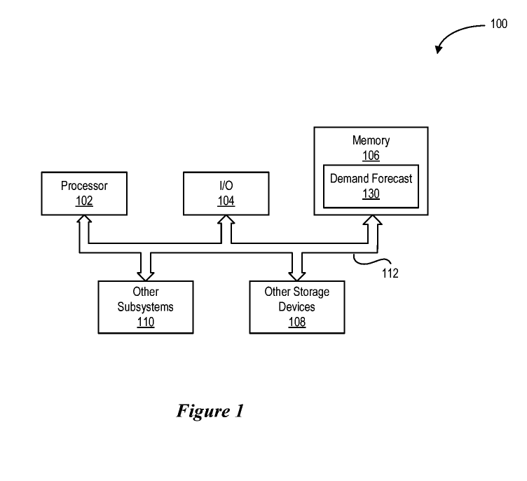

Referring briefly to FIG. 1, a system block diagram of an information handling system 100 is shown. The information handling system 100 includes a processor 102, input/output (I/O) devices 104, such as a display, a keyboard, a mouse, and associated controllers, memory 106 including volatile memory such as random access memory (RAM0 and non-volatile memory such as a hard disk and drive, and other storage devices 108, such as a floppy disk and drive and other memory devices, and various other subsystems 110, all interconnected via one or more buses 112. The memory includes a demand forecast system 130 which provides a comprehensive and flexible method for predicting field service head count requirements for optimized field delivery. The headcount model predicts how many field service resources (be they internal resources or partner resources) are needed both for a particular timeframe and at a particular location. E.g., the resources can be predicted by quarter and as well as by geographic location (e.g., a city or region in the USA).

The demand forecast system 130 represents demand for a service as compared to conventional product based forecasts. Also, the demand forecast system 130 takes into account several personnel related items such as attrition, ramp time and productivity improvements to predict headcount. Also, the demand forecast system 130 provides headcount plans for both internal and partner resources. Also, the demand forecast system 130 is flexible and can alter an internal to partner resource mix to incorporate changes in partner strategy. Also, the demand forecast system 130 forecasts resources by location. For example, the demand forecast system 130 includes a comprehensive model which maps mailing codes (such as zip codes) to a metropolitan area for which resources are provided.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

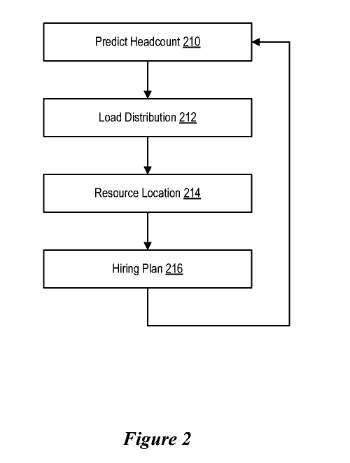

Referring to FIG. 2, a flow chart of the operation of a demand forecast system 130 is shown. More specifically, the demand forecast system 130 predicts headcount at step 210. Next, the demand forecast system 130 determines a field resource load distribution at step 212. Next, the demand forecast system 130 determines resource location at step 214. Next, the demand forecast system 130 generates a hiring plan for field resources at step 216. The demand forecast system reduces cost while maximizing customer service level.

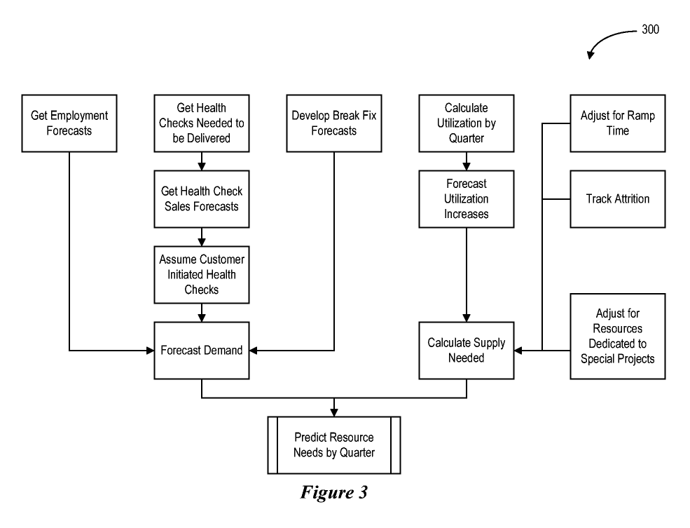

Referring to FIG. 3, a flow chart of the operation of a headcount prediction module 300 for predicting headcount is shown. During operation of the headcount prediction module 300, the demand forecast system 130 first generates demand forecasts for each of three types of customer engagements. The three types include Deployments (Equipment installation), Health Checks (Maintenance) and Critical Response (repair or Break/Fix). The demand patterns for each of the types of customer engagements depend on sales performance, product quality, competitive environment and macroeconomic trends. The forecasting methodology applied includes the ability to provide demand for a service which in turn is based on demand for various products. After the demand is estimated by quarter, the supply of headcount is calculated by using a plurality of parameters. The parameters include some or all of i) utilization (jobs per week) of an engineer based on the type of job; ii) estimated efficiency improvements; iii) training ramp time for new hires; iv) attrition; and, v) headcount dedicated to work not related to customer engagements.

The final of the headcount prediction module 300 is adjusted to account for the tradeoff such as customer service level versus cost. Thus, the more engineers used as field service resources, the higher the cost to the service provider and lower are the customer lead times. However, it is desirable to optimize cost and customer service level. Such an optimization is achieved via the demand forecast system 130. The gap between the demand and supply leads to the desirability of headcount prediction.

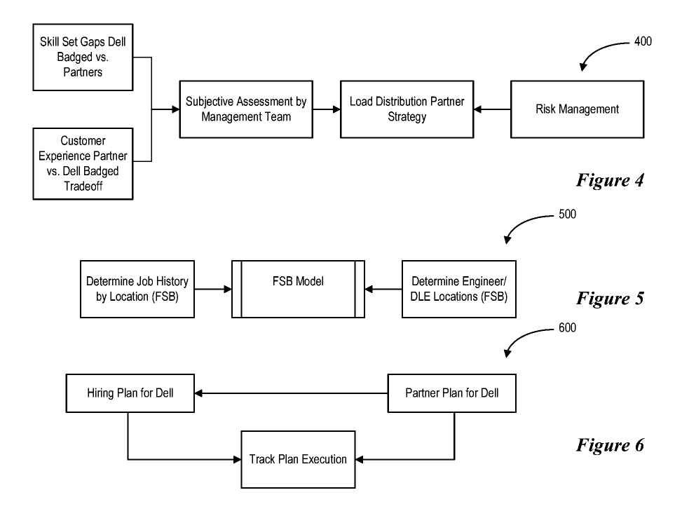

Referring to FIG. 4, a flow chart of the operation of a load distribution module 400 is shown. The load distribution module 400 determines a load distribution between internal field resources and partner (i.e., external) field resources. During the operation of the load distribution module 400, the field resources system 130 considers a plurality of load distribution parameters. The load distribution parameters include skill set differences between internal resources and partner resources as well as risk management factors between internal resources and partner resources. Examples of risk management factors include percent of internal resources, percent dedicated resources (including internal and external dedicated resources) and percent external resources Thus, the load distribution module 400 separates headcount predictions by internal head count and partner head count.

Referring to FIG. 5, a flow chart of the operation of a resource location module 500 is shown. Based upon the hiring plan generated by the load distribution module 400, the resource location module 400 determines location of where to provide the identified resources. The resource location module 400 uses a Field Stocking Branch (FSB) model. With the FSB model, every zip code in the United States is mapped to a corresponding field stocking branch. For example, in one embodiment, the demand forecast system 130 includes 57 field stocking branches which correspond to each of the major metropolitan areas in the United States. The location recommendation is based on the demand and supply gap in that metropolitan area and is intended to reduce travel time and cost. By using a FSB model, significant savings can be achieved by reducing travel time and cost for field service resources.

Referring to FIG. 6, a flow chart of the operation of a hiring plan module is shown. The hiring plan module 600 of the demand forecast system 130 uses the information generated by the other modules and converts this information into an execution plan which can be tracked. Deviations from the execution plan are then factored in as input to the headcount prediction module 300 when the demand forecast system 130 is next executed.

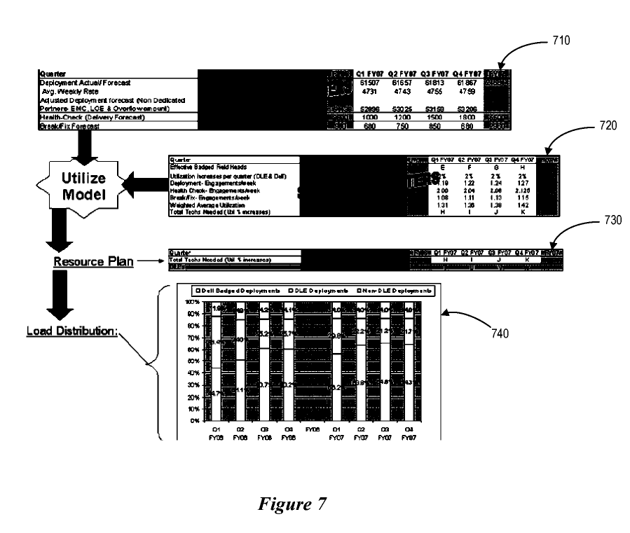

FIG. 7 shows a series of sample screen presentations representing the operation of the demand forecast system 130. More specifically, during the operation of the headcount prediction module 210, a demand parameters presentation 710 is presented. Next, during the load distribution module 212 a supply parameter presentation 720 is presented. Next, during operation of the resource location module 214, a resource plan presentation 730 is presented. Next, during operation of the hiring plan module 216, a load distribution presentation 740 is presented.

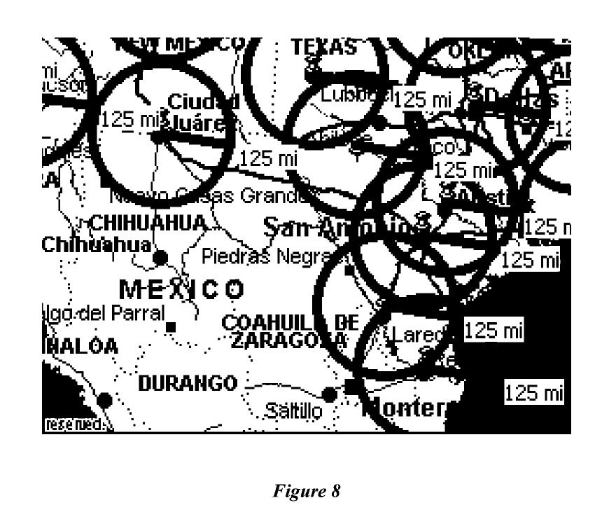

FIG. 8 shows an example of a geographic distribution of a resource location module. While only a subsection of a United States map are shown, the demand forecast system 130 uses geographic distributions across the rest of the North American continent. Various geographic regions for which field service is provided may be grouped by major metropolitan areas. Some geographic regions may overlap a number of metropolitan areas, while other geographic regions are only associated with a single metropolitan area. The demand forecast system 130 can add additional geographic areas as necessary. Additionally, geographic areas may be added for other parts of the world.

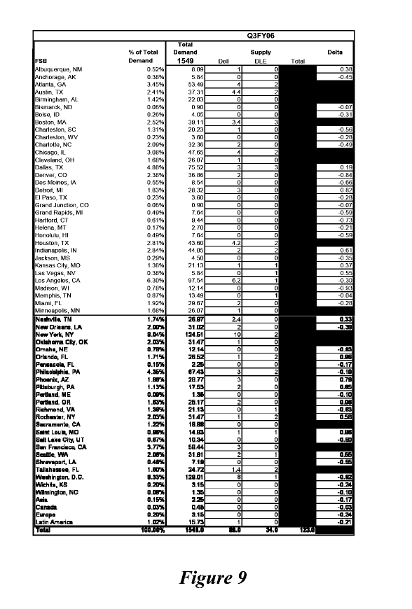

FIG. 9 shows sample screen presentations of a breakdown of field resources by field service branch of the demand forecast system. The breakdown includes a total number of field resources as well as a geographic breakdown of field resources and a load distribution breakdown of field resources.

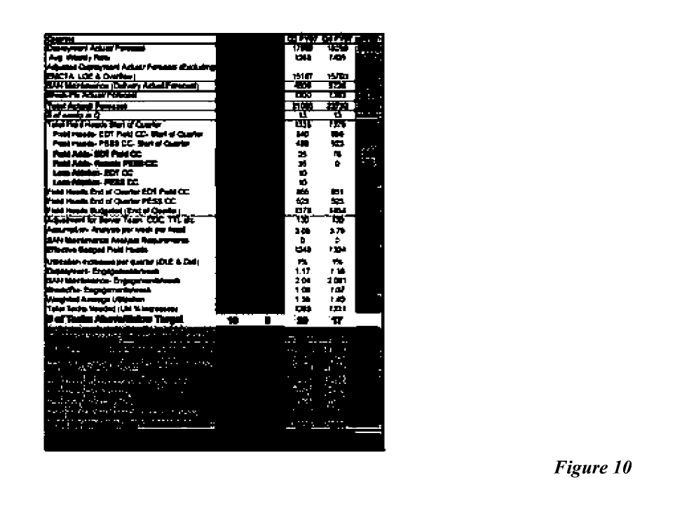

FIG. 10 shows a sample screen presentation of a sample execution plan of the demand forecast system 130. The execution plan includes proposed hiring needs both internal and partner as well as breakdowns that include forecasts based upon the types of deployments as well as locations. The execution plan is also divided into segments of time for which the execution plan is applicable (e.g., by fiscal quarter).

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Also, for example, the above-discussed embodiments include modules that perform certain tasks. The modules discussed herein may include script, batch, or other executable files. The modules may be stored on a machine-readable or computer-readable storage medium such as a disk drive. Storage devices used for storing modules in accordance with an embodiment of the invention may be magnetic floppy disks, hard disks, or optical discs such as CD-ROMs or CD-Rs. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A computer implemented method for predicting field service resource needs comprising:
predicting a field service resource headcount;
determining a field service resource load distribution;
determining a field service resource location distribution; and,
generating a hiring plan for the field service resources based upon the headcount, field service resource load distribution and field service resource location distribution.

2. The method of claim 1 wherein
the predicting a field service resource headcount includes generating demand forecast for a plurality of types of customer engagements.

3. The method of claim 1 wherein
the customer engagements include at least one of equipment installation engagements, maintenance engagements and repair engagements.

4. The method of claim 2 wherein
the demand forecast is based upon demand patterns; and,
the demand patterns are based upon sales performance, product quality, competitive environment and macroeconomic trends.

5. The method of claim 1 wherein
the determining field service resource load distribution includes determining a load distribution between internal field resources and external field resource.

6. The method of claim 5 wherein
the determining a load distribution between internal field resources and external field resource is based upon skill set differences between internal resource and external resources and risk management factors between internal resources and external resources.

7. The method of claim 1 wherein
the determining field service resource location includes determining using a field stocking branch model to determine field service resource location needs.

8. The method of claim 7 wherein
the field service resource location needs are based upon demand and supply gaps within metropolitan areas.

9. The method of claim 1 wherein
the generating a hiring plan includes converting information regarding field resource headcount, field service resource load and field service resource location distribution into a trackable execution plan.

10. A computer implemented apparatus for predicting field service resource needs comprising:
means for predicting a field service resource headcount;
means for determining a field service resource load distribution;
means for determining a field service resource location distribution; and,
means for generating a hiring plan for the field service resources based upon the headcount, field service resource load distribution and field service resource location distribution.

11. The apparatus of claim 10 wherein
the means for predicting a field service resource headcount includes means for generating demand forecast for a plurality of types of customer engagements.

12. The apparatus of claim 10 wherein
the customer engagements include at least one of equipment installation engagements, maintenance engagements and repair engagements.

13. The apparatus of claim 11 wherein
the demand forecast is based upon demand patterns; and,
the demand patterns are based upon sales performance, product quality, competitive environment and macroeconomic trends.

14. The apparatus of claim 10 wherein
the means for determining field service resource load distribution includes means for determining a load distribution between internal field resources and external field resource.

15. The apparatus of claim 14 wherein
the means for determining a load distribution between internal field resources and external field resource is based upon skill set differences between internal resource and external resources and risk management factors between internal resources and external resources.

16. The apparatus of claim 10 wherein
the means for determining field service resource location includes means for determining using a field stocking branch model to determine field service resource location needs.

17. The apparatus of claim 16 wherein
the field service resource location needs are based upon demand and supply gaps within metropolitan areas.

18. The apparatus of claim 10 wherein
the means for generating a hiring plan includes means for converting information regarding field resource headcount, field service resource load and field service resource location distribution into a trackable execution plan.
